(19) United States
(12) Patent Application Publication
(10) Pub. No.: US 2023/0196830 A1
(43) Pub. Date: Jun. 22, 2023

(54) VERIFICATION OF LIVENESS AND PERSON ID TO CERTIFY DIGITAL IMAGE

(71) Applicant: Lenovo (Singapore) Pte. Ltd., Singapore (SG)

(72) Inventors: Arnold Weksler, Raleigh, NC (US); John C. Mese, Cary, NC (US); Nathan Peterson, Oxford, NC (US); Russell Speight VanBlon, Raleigh, NC (US); Mark Delaney, Raleigh, NC (US)

(21) Appl. No.: 17/555,194

(22) Filed: Dec. 17, 2021

(51) Int. Cl. G06V 40/16; G06V 40/40; H04N 5/232; G06V 10/10; G06V 40/50; G06K 1/12; G06K 19/06

(52) U.S. Cl. CPC G06V 40/172; G06V 40/45; H04N 5/23229; G06V 10/17; G06V 40/50; G06K 1/121; G06K 19/06037

(57) ABSTRACT

In one aspect, a first device may include at least one processor, a camera accessible to the at least one processor, and storage accessible to the at least one processor. The storage may include instructions executable by the at least one processor to perform liveness detection to verify that a person is live in front of the camera, perform facial recognition to identify the person, and validate digital data such as a digital certificate as associated with the person. Based on the verification, facial recognition, and validation, the instructions may then be executable to store an image from the camera showing the person at a storage location accessible to other devices besides the first device.

### FIELD

The disclosure below relates to technically inventive, non-routine solutions that are necessarily rooted in computer technology and that produce concrete technical improvements. In particular, the disclosure below relates to techniques for verification of liveness and person identification (ID) to certify a digital image.

### BACKGROUND

As recognized herein, people often have to go to an authorized entity like a department of motor vehicles (DMV) or company security team to have the appropriate authority take a photograph of them for a picture ID. However, these photographs are often updated very infrequently and, as also recognized herein, people's faces and other features might change over time and therefore the photograph might become outdated. This in turn can lead to others who are looking at the photograph being unable to accurately verify that the person shown in the photograph is the same person presenting themselves in person.

The present disclosure also recognizes that modern technology has not yet found a satisfactory technical solution to this problem that can obviate the need for a person to undertake the time-consuming task of physically going to a DMV or other third party for a new photograph each time their face changes, particularly since electronic technical solutions have heretofore been too insecure for remote updating of a photograph. Thus, there are presently no adequate solutions to the foregoing computer-related, technological problem.

### SUMMARY

Accordingly, it is in this context that the disclosure below presents various technical solutions.

Thus, in one aspect a first device includes at least one processor, a camera accessible to the at least one processor, and storage accessible to the at least one processor. The storage includes instructions executable by the at least one processor to receive one or more first images from the camera and, based on the one or more first images from the camera, perform liveness detection to verify that a person shown in the one or more first images is live in front of the camera. The instructions are also executable to perform facial recognition using the one or more first images from the camera and a reference image to verify that the person shown in the one or more first images is the same person shown in the reference image. The instructions are then executable to receive and validate a digital certificate as associated with the person and, based on the verifications and validation, store a second image from the camera showing the person at a storage location accessible to other devices besides the first device.

In some examples, the instructions may be executable to, based on the verifications and validation and prior to storing the second image, digitally sign the second image with the digital certificate associated with the person. If desired, the instructions may also be executable to, based on the verifications and validation, include a timestamp for the second image in metadata associated with the second image. Additionally, or alternatively, the instructions may be executable to include a timestamp for the second image by visually encoding the timestamp onto the second image based on the verifications and validation.

In various examples, the instructions may be executable to store the second image at a server accessible over the Internet, where the server may include the storage location.

Still further, if desired in some examples the instructions may be executable to associate the second image with a quick response (QR) code so that the QR code points to the storage location. The instructions may then be executable to print the QR code onto a substrate and/or electronically transmit the QR code to a third party.

In some example implementations, the reference image itself may be accessed from a remote storage location for verifying that the person shown in the one or more first images is the same person shown in the reference image.

Also in some example implementations, the second image may be selected from the one or more first images.

In still another aspect, a method includes receiving one or more first images from a camera and, based on the one or more first images from the camera, performing liveness detection to verify that a person shown in the one or more first images is live in front of the camera. The method also includes performing facial recognition using the one or more first images from the camera to verify that the person shown in the one or more first images is the same person shown in a reference image. The method then includes validating a digital certificate as associated with the person. The method also includes, based on the verifications and validation, storing a second image from the camera showing the person at a storage location accessible to plural devices.

In some examples, the method may be performed at a client device. Additionally, or alternatively, the camera may be located on a client device and the method may be performed at least in part using a server.

Additionally, in some example implementations the method may include digitally signing the second image with the digital certificate associated with the person based on the verifications and validation. Also based on the verifications and validation, in certain example implementations the method may include including a timestamp for the second image in metadata associated with the second image.

Still further, in some embodiments the method may include associating the second image with an identifier so that the identifier indicates the storage location. The identifier may then be printed onto a substrate, made electronically accessible to the plural devices, and/or electronically transmitted to a third party.

Also note that in some examples the second image may be selected from the one or more first images.

In still another aspect, at least one computer readable storage medium (CRSM) that is not a transitory signal includes instructions executable by at least one processor to perform liveness detection to verify that a person is live in front of a camera, perform facial recognition to identify the person, and validate digital data as associated with the person. The digital data is issued by a third party and is not data from the camera. The instructions are then executable to, based on the verification, facial recognition, and validation, store an image from the camera showing the person at a storage location accessible to plural devices.

In some examples, the instructions may also be executable to store the image at the storage location with a timestamp associated with the image.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIGS. 3-8 indicate various example graphical user interfaces (GUIs) that may be presented at various stages of a process to update a user's certified photograph consistent with present principles;

FIG. 9 illustrates example logic in example flow chart format that may be executed by a device to update a user's certified photograph consistent with present principles; and

FIG. 10 shows an example settings GUI that may be presented to configure one or more settings of a device to operate consistent with present principles.

### DETAILED DESCRIPTION

Among other things, the detailed description below discloses use of metadata on or associated with a digital photograph of a person to indicate a certified date for the photo as well as certifying the picture with the user's certification using various cryptography methods. Thus, when an identification (ID) picture is taken, such as for a driver's license, profile photo, passport, meeting photo, badge photo, website photo, or other virtual or physical location photo, the following may be performed.

First, a client device camera may use liveness detection to ensure that the picture is being taken of a real person and not another photograph. The client device may then use facial detection/recognition to compare an older picture with the current picture to ensure that the same person is being photographed. Thereafter, the person themselves may use their security credentials such as a trusted user certificate to ensure the user is who they claim they are.

The new picture may then be posted with the date the picture was taken. In this fashion, aging of the picture can then be accomplished for the next time cycle. In certain examples, the website or entity might even require a new picture within a configured value such as every month, six months, annually, or whatever.

Additionally, in some examples a hard copy ID can have a reference like a QR code that will point to the current picture in electronic storage.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino, Calif., Google Inc. of Mountain View, Calif., or Microsoft Corp. of Redmond, Wash.. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM, or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI and includes programmable logic components programmed to perform the functions of an embodiment as well as general-purpose or special-purpose processors programmed with instructions to perform those functions.

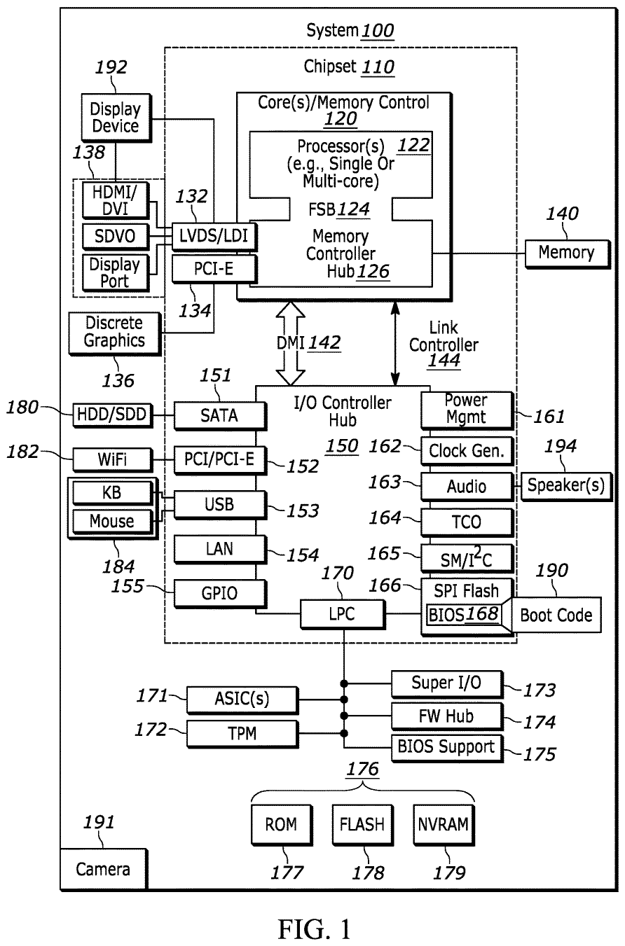

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing, or reading and writing information on one or more drives 180 such as HDDs, SDDs or a combination thereof, but in any case, the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

As also shown in FIG. 1, the system 100 may also include a camera 191 that gathers one or more images and provides the images and related input to the processor 122. The camera 191 may be a thermal imaging camera, an infrared (IR) camera, a digital camera such as a webcam, a three-dimensional (3D) camera, and/or a camera otherwise integrated into the system 100 and controllable by the processor 122 to gather still images and/or video consistent with present principles (e.g., to update a photo ID).

Additionally, though not shown for simplicity, in some embodiments the system 100 may include a gyroscope that senses and/or measures the orientation of the system 100 and provides related input to the processor 122, as well as an accelerometer that senses acceleration and/or movement of the system 100 and provides related input to the processor 122. Still further, the system 100 may include an audio receiver/microphone that provides input from the microphone to the processor 122 based on audio that is detected, such as via a user providing audible input to the microphone. Also, the system 100 may include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

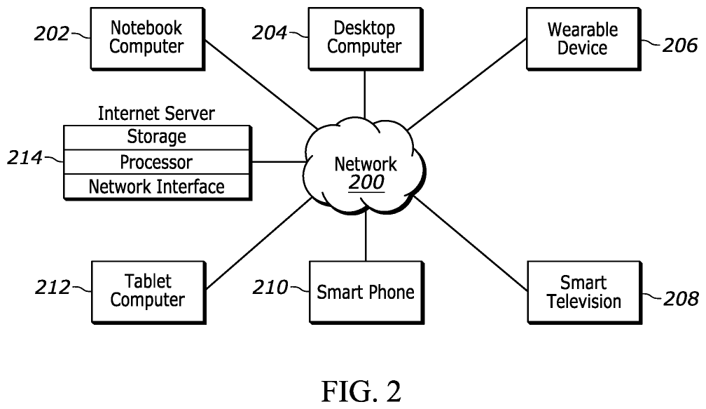

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles (e.g., to store a certified digital image at a remote storage location accessible to other devices).

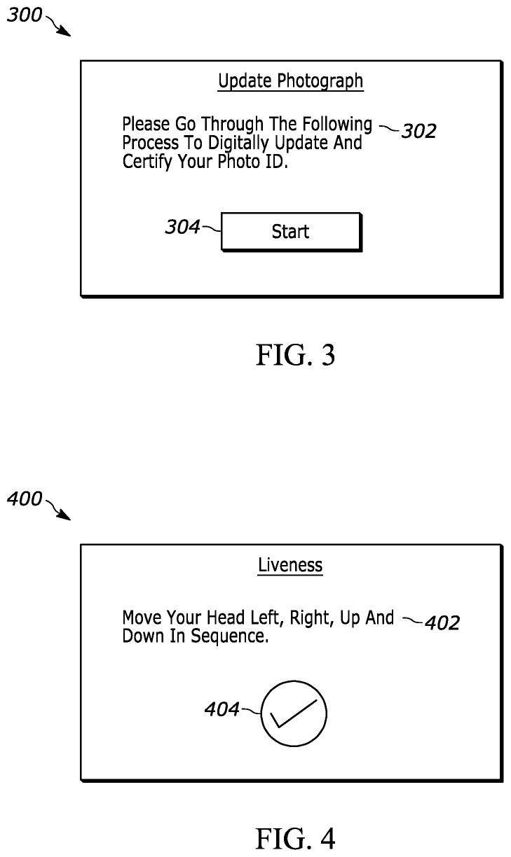

Referring now to FIG. 3, suppose an end-user wishes to update their photo identification (ID) with a newer image of themselves that is more up to date with their actual, current appearance. This might be due to a variety of reasons, such as plastic surgery and other cosmetic changes, a vehicle accident, facial hair that has been grown, a change in hairstyle, or just the process of aging. To do so, the user may launch a dedicated software application (“app”) or operating system-level software from their client device which, either by itself or on conjunction with a server with which the client device communicates, performs the following example process that starts with the graphical user interface (GUI) 300 of FIG. 3.

As shown in FIG. 3, responsive to the app being launched (and possibly after the user has indicated which photo ID is to be updated), the GUI 300 may be presented to provide instructions 302. The instructions 302 may indicate that the user is to follow ensuing prompts to digitally update and certify a new image to use for their photo ID. When the user is ready to begin, the user may select the start selector 304.

Responsive to selection of the selector 304, the GUI 400 may then be presented. Instructions 402 may indicate that, for liveness detection, the user should move his/her head in the particular sequence indicated in the instructions 402 while in front of the client device's digital camera for the client device (or server) to verify from video provided by the camera that the person is live in front of the camera. This may be done to ensure a nefarious actor does not simply present a still photograph of another person to the camera to fraudulently “update” the ID of the other person. Example liveness detection algorithms that may be used include Apple's FaceID liveness detection, FaceTec's liveness detection, and BioID's liveness detection, but other suitable liveness detection algorithms may also be used to verify that a person is physically and tangibly present in front of the client device's camera rather than the person merely being shown in an old, still photograph presented to the camera (or otherwise spoofed through electronic means).

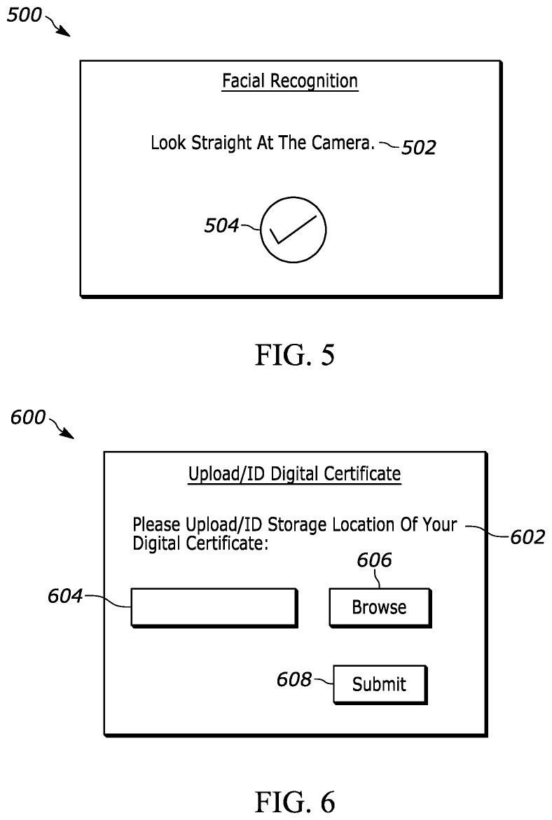

Thus, the device may use images from the camera to monitor the user in performing the instructions 402 and then, once liveness has been verified, present a green check 404 as a dynamic update to the GUI 400 to indicate that liveness detection has been completed and the user's liveness verified. Thereafter, the GUI 500 of FIG. 5 may be presented after the check 404 has been presented for a threshold amount of time (e.g., five seconds).

Accordingly, reference is now made to the GUI 500 of FIG. 5. This GUI shows that the next step in the example process is to perform facial recognition using live images from the camera to verify that the person shown in the live images is the same person shown in an older certified image and/or for which a biometric face ID has already been registered. For example, the user may be instructed via the instructions 502 to look straight at the camera for the device/server to compare and verify that the person shown in the live images from the camera is the same person shown in one or more reference images accessible to the device. The reference image may be accessed from a remote storage location, such as one hosted by a third party like a DMV or other government agency or whatever third party initially issued the photo ID that is being updated. The reference image may also be accessed based on receipt of a digital photograph provided by the person that shows the person's existing photo ID, which itself would show the reference image (e.g., the user uses the same camera to take a picture of their photo ID while participating in the current process). Or the user may hold up their existing photo ID to the camera for the camera to extract the reference image therefrom in real time.

The overall facial recognition match itself may be required to be within a threshold level of confidence such as ninety percent, for example, or may be more particularized in that the app may be configured to compare specific facial features between the live image(s) and reference image that are less likely to change. This may include, for example, matching at least ten feature points of the user's eyes/iris/eye area between the live and reference images, where fifteen feature points are available. Or as another method, two-thirds of all feature points for one or more specific facial features may have to be matched for successful verification. Besides eyes/eye area, another example facial feature might be a user's mouth or even a user's teeth.

Then once facial recognition has been performed and a facial recognition match has been verified, a green check mark 504 may be presented as a dynamic update to the GUI 500. Thereafter, the GUI 600 of FIG. 6 may be presented after the check 504 has been presented for a threshold amount of time (e.g., five seconds).

As shown in FIG. 6, the GUI 600 may include instructions 602 that the user is to upload or otherwise indicate a storage location of a digital certificate or other digital data associated with the person. The digital certificate or other data (that may not be data from the camera itself) may be issued by a third party such as the agency that initially issued the user's photo ID, a certificate authority, or even a private digital security company that provides valid digital certificates to people. Thus, the user may either upload or enter the storage location of the certificate into input box 604, possibly after browsing for the digital certificate (or other data) first via a file browser responsive to selection of the browse selector 606. After that, the user may select the submit selector 608 for the client device (and/or server) to validate the uploaded digital certificate or other data as associated with the same user for which liveness and facial recognition have been verified.

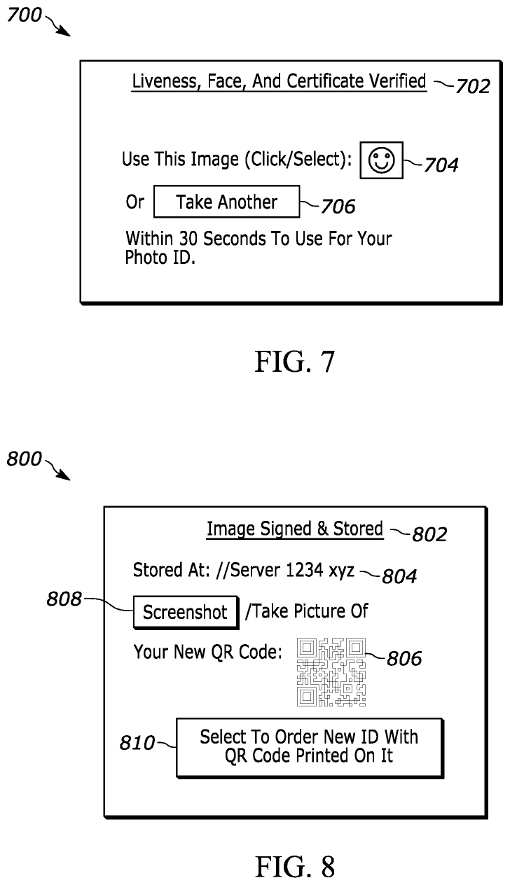

Then, responsive to the verifications and digital certificate validation, the GUI 700 of FIG. 7 may be presented. As shown in FIG. 7, the GUI 700 may include an indication 702 that the user's liveness and face have been verified and that the digital certificate has been validated as associated with the user. The GUI 700 may also provide various options from which a user may select a particular digital image to use as the updated image for their photo ID. One such option may be in the form of a thumbnail 704 of one of the images from the camera that have already been received and was autonomously selected by the device itself. The device may select a given image from the images already received by executing facial/object recognition on the images to select an image that both shows the user smiling and shows the user with their eyes open (as opposed to being in the process of blinking). If more than one image satisfies the criteria, then the image from the conforming subset that shows the user smiling the biggest/with the greatest width may be selected.

Another option for a user to select a digital image to use as the updated image for their photo ID includes a selector 706 that may be selected to initiate an electronic timer at the device within which the user may control the camera himself/herself to take another digital image the user wishes to use. The timer may be used so that the user does not have an indefinite period of time to do so, which might lead to a nefarious third party trying to spoof the user and generate a photograph of another person after the user steps away from the device. The timer also ensures that the liveness detection and facial recognition that have already been performed remain valid without too many intervening events that may necessitate starting the process over. In the present example, the timer is set to thirty seconds.

Then after the user selects a particular single digital image/photograph to use as the updated image for their photo ID, the GUI 800 of FIG. 8 may be presented. As shown in this figure, the GUI 800 may include an indication 802 that the selected image has now been digitally signed and electronically stored, which may occur transparently to the user on the backend after the user selects the image to use. The GUI 800 may also include a file path and/or server ID (e.g., IP address) 804 indicating a storage location that is accessible to other devices for third parties to lookup the updated image.

Furthermore, in some examples the client device/server facilitating the process may generate a quick response (QR) code 806 or other identifier such as a barcode or Microsoft Tag that points to/indicates the storage location at which the updated image is located. The code 806 may then be scanned using the camera of another device to take the other device to the storage location itself to access the updated image at a later time.

For example, the QR code 806 may be printed on a driver's license or passport so that a government official can scan the QR code 806 as printed on the license or passport with their own camera to then access the updated image rather than an out-of-date older image that might be printed on the physical copy of the license or passport itself. If desired, the GUI 800 may even include a selector 810 that may be selected to automatically submit an order to the appropriate government agency or third party for a new physical document (license, passport, corporate ID badge, profile photo, etc.) with the QR code 806 manually and physically printed on the document itself using ink for later scanning using another camera. If desired, the new physical document that is ordered may also be printed with the user's updated image that was just stored at the storage location denoted by the QR code. The QR code 806 may thus point to the same updated image as shown on the physical document that is ordered for the time being but may also be used to point to other update images that might be uploaded later and stored at the same storage location to replace a previous update image.

As another example, note that selector 808 may also be selected to command the user's own client device to automatically take a screenshot of the GUI 800 or just the QR code 806 in particular for local or remote storage for the user to subsequently produce the QR code himself/herself electronically through the display of their client device.

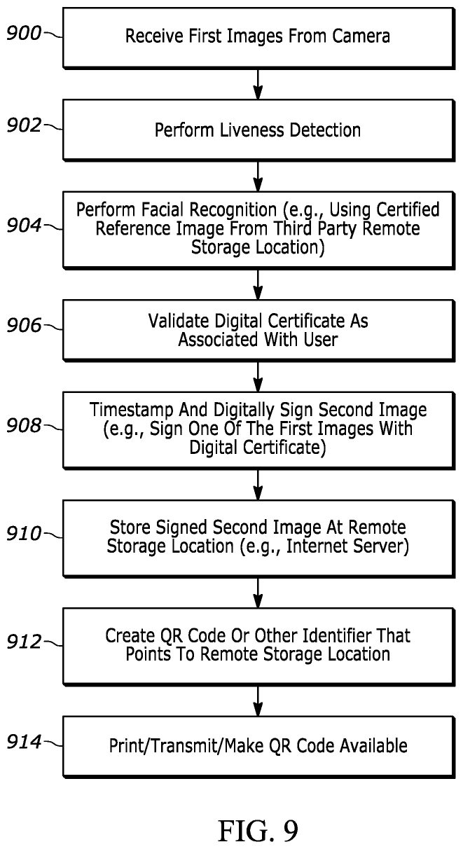

Continuing the detailed description in reference to FIG. 9, it shows example logic that may be executed by a device such as the system 100, the client device described above, and/or a remotely-located server alone or in any appropriate combination consistent with present principles. Note that while the logic of FIG. 9 is shown in flow chart format, other suitable logic may also be used. Also note that while various steps will be described below as occurring in a particular sequence, they may be performed in a different sequence as well. For example, digital certificate validation and facial recognition may be performed before liveness detection if desired.

In any case, beginning at block 900, the device may receive one or more first images from a camera to, at block 902, perform liveness detection as described above to verify that a person is presenting themselves live in front of the camera (e.g., rather than fraudulently attempting to register a person shown in a still picture/photograph). The logic may then move to block 904 where the device may use at least one of the one or more first images to perform facial recognition to compare facial features from the one or more first images to a certified or other reference image as may be accessed from a third party remote storage location or provided by the user themselves (e.g., via an image of the user's current physical/tangible photo ID itself). Additionally, as an added layer for even greater security, in some embodiments the user may also be prompted to provide a voice sample via a local microphone for execution of voice recognition to ID the user using a template of the user's voice. After verifying the user's face from the first images as matching the reference image to within a threshold level of confidence (and possibly also identifying the user through voice recognition), the logic may then move to block 906.

At block 906 the device may validate a digital certificate provided by the user as actually being associated with the user. For example, at block 906 the device may identify the real name or username indicated on the digital certificate as matching the real name or username of the user as identified through facial recognition. If digital data other than a digital certificate is used, the digital data might be a trusted key or other piece of data that can be validated (e.g., over the Internet) as already associated with the user. Thereafter, the logic may proceed to block 908.

At block 908 the device may timestamp and then digitally sign a second image, where the second image may be one of the first images that the user ultimately selects as described in reference to FIG. 7 above. Or the second image may be one of the first images that is automatically selected by the device itself as described above (e.g., based on the user smiling the biggest in that image), or may be an image that was taken at a later time responsive to selection of the selector 706 of FIG. 7.

The second image may be signed with the same digital certificate that the user already indicated as associated with the user and that was issued by the appropriate issuing authority or agency to certify the user. The timestamp itself may be included in metadata accompanying the second image that is signed with the digital signature. The timestamp may indicate the date and time the second image was actually generated, the date and time the verification and validation steps above were completed, the date and time the second image was digitally signed as set forth below, the date and time the second image is ultimately uploaded to remote storage later at block 910, etc.

However, instead of using the digital certificate itself, further note that the second image may be digitally signed other ways, such as with a private encryption key issued by the appropriate authority or third-party security/ID verification service so that the signature may be decrypted with the reciprocal public encryption key later for signature validation. Note that here too the timestamp may be included in the metadata accompanying the second image and may be signed along with the second image itself.

In addition to or in lieu of the foregoing, but also at block 908, note that the second image may also be timestamped by visually encoding/embedding the timestamp on the second image itself (e.g., a lower left or right hand corner) prior to the second image being digitally signed (with the digital certificate or other private key) so that the timestamp can be readily appreciated at a later time when someone views the second image itself. For example, timestamp text may be overlaid on a predetermined area of the second image and/or certain pixel values of the second image itself may be changed to visually indicate the timestamp text at the predetermined area. Example timestamp text might indicate on the face of the second image, for example, “Image taken/certified on Apr. 2, 2019, at 2:52 p.m. EST”.

Additionally or alternatively, note that the key credentials for the digital signature key itself may be stored into the second image's metadata that is then digitally signed so that the key credentials themselves establish a timestamp, in that the associated key might only be considered current and valid for a predefined amount of time during which the second image is certified and that may be indicated in the credentials stored in the metadata, thereby indicating the second image was generated, certified, etc. during that time.

Thus, regardless of which particular implementation discussed above is used, by digitally signing the timestamp, the integrity of the timestamp may be maintained so a nefarious actor would have trouble altering/spoofing it for use with an outdated photo (e.g., altering it while the second image is in transit to a remote storage location as described immediately below).

From block 908 the logic may then move to block 910. At block 910 the device may store the second image (and associated metadata/timestamp) at a storage location accessible to other devices besides the first device. For example, the storage location may be a remote storage location on a remotely-located, secure server. The second image may be transmitted to the storage location in encrypted form for even greater digital security, e.g., using hypertext transfer protocol secure (HTTPS) communication such as HTTP over TLS (transport layer security) or HTTP over SSL (secure sockets layer). However, the storage location might also be personal cloud storage for the user himself/herself or even local hard disk or solid-state storage of one of the user's own client devices. In any case, further note that regardless of where stored, the certifying authority itself (e.g., DMV or corporate security team) may attach/sign their own digital certificate to the second image to certify that it is authentic and valid according to their standards.

In some examples and for even greater digital security, the second image may be stored at the storage location in encrypted form so that only an appropriate government agency or third party with the appropriate decryption key can decrypt and access the second image (and associated metadata) as stored at the storage location. Thus, the second image itself may not be left on the open Internet for others to access/copy and possibly misuse for nefarious purposes such as to create a fake paper/tangible ID using the second image. However, note that in other embodiments the second image as stored at the storage location may be left unencrypted so that anyone can access to second image to validate that a person presenting themselves in person is the same person shown in the second image.

From block 910 the logic may then proceed to block 912. At block 912 the device may use a QR code generator app or other software to create a QR code to associate with the second image by pointing to the storage location at which the second image itself is stored. However, note that other identifiers besides a QR code might also be used to indicate the storage location, including other identifiers already described above or even a uniform resource locator (URL). From block 912 the logic may then proceed to block 914.

At block 914 the device may then print the QR code (or other identifier) onto a substrate such as an updated physical, tangible photo ID for the user like a passport, driver's license, private company security credential/ID badge, etc. so that the tangible photo ID with the updated (second) image may be provided (e.g., mailed) to the user himself/herself. Additionally or alternatively, at block 914 the device may electronically transmit the QR code to a third party that might need to use the second image to identify the user, or otherwise make the QR code electronically available for access (e.g., store it remotely for remote access, or even store it locally at the user's device as an image or screenshot so the user may present it using their own client device display to someone else seeking to verify the user's identity).

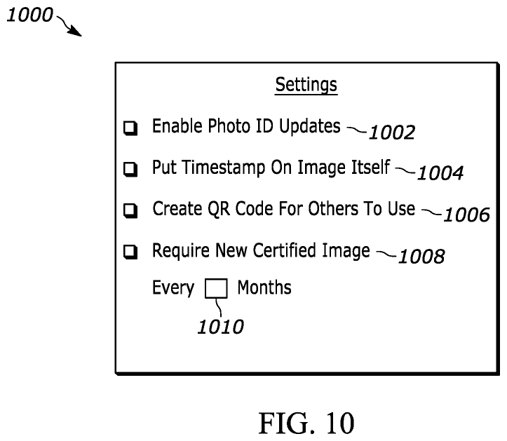

Now describing FIG. 10, it shows an example GUI 1000 that may be presented on the display of a device configured to undertake present principles in order to set or enable one or more settings of the device to operate consistent with present principles. For example, the GUI 1000 may be reached by navigating a settings menu of a user's own client device or a settings menu of an ID authority to configure settings of its system for end-users to update their photos as described above. Also note that in the example shown, each option discussed below may be selected by directing touch or cursor input to the respective check box adjacent to the respective option.

As shown in FIG. 10, the GUI 1000 may include an option 1002 to set or configure the device/system to in the future perform the functions described herein, including allowing end-users to update images used for their photo IDs. For example, the option 1002 may be configured to set or enable the client devices/servers discussed above to perform the functions described above in reference to FIGS. 3-8 as well as to execute the logic of FIG. 9.

The GUI 1000 may also include an option 1004 to specifically set or configure the device/system to include timestamps with updated images of users as also described above. Still further, if desired the GUI 1000 may include an option 1006 to set or configure the device/system to create QR codes or other identifiers for others to use to access an updated image of a user as described herein.

Moreover, in some examples the GUI 1000 may include an option 1008 that may be selected to set or configure the device/system to require a user to provide a new image for certification and storing for identity validation purposes every X weeks, months, years, etc. In the present example, input may be directed to input box 1010 to establish the associated time window in terms of a number of months. Thus, after expiration of the time window, the most-recent photo ID update image may be deleted from its storage location (or at least invalidated) and, for example, the GUI 300 of FIG. 3 may be automatically presented as a prompt at the user's client device for the user to provide a newer image of themselves to use along with a warning that failure to do so may result in their identity not being able to be validated owing to only outdated/expired photographs being available for such purposes.

It may now be appreciated that present principles provide for an improved computer-based user interface that increases the functionality, security, and ease of use of the devices and electronic systems disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged, or excluded from other embodiments.

1. A first device, comprising:
at least one processor;
a camera accessible to the at least one processor; and
storage accessible to the at least one processor and comprising instructions executable by the at least one processor to:
receive one or more first images from the camera;
based on the one or more first images from the camera, perform liveness detection to verify that a person shown in the one or more first images is live in front of the camera;
perform facial recognition using at least one of the one or more first images from the camera and a reference image to verify that the person shown in the one or more first images is the same person shown in the reference image;
receive and validate a digital certificate as associated with the person; and
based on the verifications and validation, store a second image from the camera showing the person, the second image stored at a storage location accessible to other devices besides the first device.

2. The first device of claim 1, wherein the instructions are executable to:
based on the verifications and validation, and prior to storing the second image, digitally sign the second image with the digital certificate associated with the person.

3. The first device of claim 1, wherein the instructions are executable to:
based on the verifications and validation, include a timestamp for the second image in metadata associated with the second image.

4. The first device of claim 1, wherein the instructions are executable to:
based on the verifications and validation, include a timestamp for the second image by visually encoding the timestamp onto the second image.

5. The first device of claim 1, wherein the instructions are executable to:
store the second image at a server accessible over the Internet, the server comprising the storage location.

6. The first device of claim 1, wherein the instructions are executable to:
associate the second image with a quick response (QR) code so that the QR code points to the storage location.

7. The first device of claim 6, wherein the instructions are executable to:
print the QR code onto a substrate.

8. The first device of claim 6, wherein the instructions are executable to:
electronically transmit the QR code to a third party.

9. The first device of claim 1, wherein the reference image is accessed from a remote storage location for verifying that the person shown in the one or more first images is the same person shown in the reference image.

10. The first device of claim 1, wherein the second image is selected from the one or more first images.

11. A method, comprising:
receiving one or more first images from a camera;
based on the one or more first images from the camera, performing liveness detection to verify that a person shown in the one or more first images is live in front of the camera;
performing facial recognition using at least one of the one or more first images from the camera to verify that the person shown in the one or more first images is the same person shown in a reference image;
validating a digital certificate as associated with the person; and
based on the verifications and validation, storing a second image from the camera showing the person, the second image stored at a storage location accessible to plural devices.

12. (canceled)

13. The method of claim 11, wherein the camera is located on a client device, and wherein the method is performed at least in part using a server.

14. The method of claim 11, comprising:
based on the verifications and validation, digitally signing the second image with the digital certificate associated with the person.

15. The method of claim 11, comprising:
based on the verifications and validation, including a timestamp for the second image in metadata associated with the second image.

16. The method of claim 11, comprising:
associating the second image with an identifier so that the identifier indicates the storage location.

17. The method of claim 16, comprising one or more of:
printing the identifier onto a substrate, making the identifier electronically accessible to the plural devices, electronically transmitting the identifier a third party.

18. (canceled)

19. At least one computer readable storage medium (CRSM) that is not a transitory signal, the computer readable storage medium comprising instructions executable by at least one processor to:
perform liveness detection to verify that a person is live in front of a camera;
perform facial recognition to identify the person;
validate digital data as associated with the person, the digital data issued by a third party and not being data from the camera; and
based on the verification, facial recognition, and validation, store an image from the camera showing the person, the image stored at a storage location accessible to plural devices.

20. (canceled)

21. The first device of claim 1, wherein the digital certificate is issued by a certificate authority.

22. The first device of claim 1, wherein the digital certificate is issued by an agency that initially issued an identity document that is being updated via the liveness detection, facial recognition, digital certificate validation, and second image storage.

23. The first device of claim 1, wherein validating the digital certificate comprises identifying a name from the digital certificate as matching a name of the person as identified through the facial recognition.
